(19) United States
(12) Patent Application Publication
(10) Pub. No.: US 2015/0191968 A1
(43) Pub. Date: Jul. 9, 2015

(54) SHELF RETAINING DEVICE

(71) Applicant: Leona Choo-Kang, Clayton, MO (US)

(72) Inventor: Leona Choo-Kang, Clayton, MO (US)

(21) Appl. No.: 14/590,066

(22) Filed: Jan. 6, 2015

Related U.S. Application Data
(60) Provisional application No. 61/924,832, filed on Jan. 8, 2014.

(51) Int. Cl. E06B 9/00; E06B 9/01

(52) U.S. Cl. CPC E06B 9/00; E06B 9/01; E06B 2009/015; E06B 2009/002

(57) ABSTRACT

A shelf retainer device is disclosed that comprises a retaining panel and a plurality of mounting units, which is particularly useful to prevent items from falling from refrigerator and freezer shelves. A method of a retaining items on a shelf is also disclosed.

### This application claims priority to U.S. provisional patent application No. 61/924,832, filed Jan. 8, 2014, the entirety of which is incorporated herein by reference.

### FIELD OF THE INVENTION

The present invention relates to a shelf retainer device for retaining items on a shelf of, for example, a refrigerator or freezer, to improve safety and increase storage capacity.

### BACKGROUND OF THE INVENTION

Home refrigerator/freezers come in a variety of configurations. Some have the freezer section on the top, some on the bottom and some have the refrigerator and freezer sections side-by-side. Each of these configurations comes with its own advantages and disadvantages. The freezer-on-top and side-by-side refrigerator/freezers have a tendency to drop items from the shelves, especially when the shelves are overcrowded. Several factors can contribute to the overcrowding of home refrigerator/freezers. Certainly, the small size of the freezer compartment compared to the main refrigerator compartment and large family size contribute to overcrowding of the freezer. In recent years however, the increased variety of foods that are available as prepared frozen foods and the consumer trend toward bulk purchasing, and thus the need for more long-term freezer storage, have greatly exacerbated this problem.

Items piled on freezer shelves, such as those in side-by-side refrigerators, can fall out when the freezer door is opened. This can create a mess or damage the frozen food items, but more importantly, a heavy frozen food item falling from an upper shelf can damage parts of the refrigerator/freezer or cause injury to the consumer. As another consequence of this phenomenon, the consumer cannot safely and conveniently utilize the full capacity of the freezer compartment without fear of causing a frozen food avalanche when the freezer door is opened. These problems can also occur with the main refrigerator compartment.

### SUMMARY OF THE INVENTION

This invention provides a shelf retainer system that is particularly useful in refrigerators and freezers.

One embodiment of the invention provides A shelf retainer device comprising a retaining panel and a plurality of mounting units, wherein: the retaining panel comprises an open mesh material and a plurality of attachment loops, and; each of the plurality of mounting units comprises an approximately L-shaped bracket having a side plate and a front plate, from which front plate extends at least one attachment knob comprising a bulbous head that fits within one of the attachment loops.

Another embodiment provides a method of retaining items on a shelf bounded by at least two walls, which comprises: providing a retaining panel comprising an open mesh material and a plurality of attachment loops; affixing a plurality of mounting units to the at least two walls, wherein each mounting unit comprises an approximately L-shaped bracket having a side plate and a front plate, from which front plate extends at least one attachment knob comprising a bulbous head; and fitting the attachment loops over the bulbous heads of the mounting units.

### BRIEF DESCRIPTION OF THE DRAWINGS

Certain, non-limiting aspects of the invention can be understood with reference to the attached figures.

FIG. 1 shows a refrigerator with a shelf retainer device of the present invention installed in the freezer compartment.

FIG. 2 illustrates a retainer panel of a shelf retainer device in a relaxed position.

FIG. 3 illustrates the retainer panel of a shelf retainer device in a stretched position.

FIG. 4 is a perspective drawing of a mounting unit of a shelf retainer device.

FIG. 5 is a top view of the mounting unit in FIG. 4.

FIG. 6 is a left side view of the mounting unit in FIG. 4.

FIG. 7 is a front view of the mounting unit in FIG. 4.

FIG. 8 is a right side view of the mounting unit in FIG. 4.

FIG. 9 is a back view of the mounting unit in FIG. 4.

FIG. 10 is a top view showing additional features of a mounting unit of a shelf retainer device.

FIG. 11 is a top view showing additional features of a mounting unit of a shelf retainer device.

FIG. 12 is a detail view of the corners of two adjacent retainer panels of a shelf retainer device.

FIG. 13 is a detail view of the corners of two adjacent retainer panels connected to a mounting unit of a shelf retainer device.

FIG. 14 is a detail view showing additional features of the corners of two adjacent retainer panels of a shelf retainer device.

FIG. 15 shows a refrigerator/freezer with a shelf retainer device installed on multiple shelves of the freezer compartment.

FIG. 16 shows a freezer-on-top style refrigerator/freezer with a shelf retainer device installed in the freezer compartment.

### DESCRIPTION OF THE INVENTION

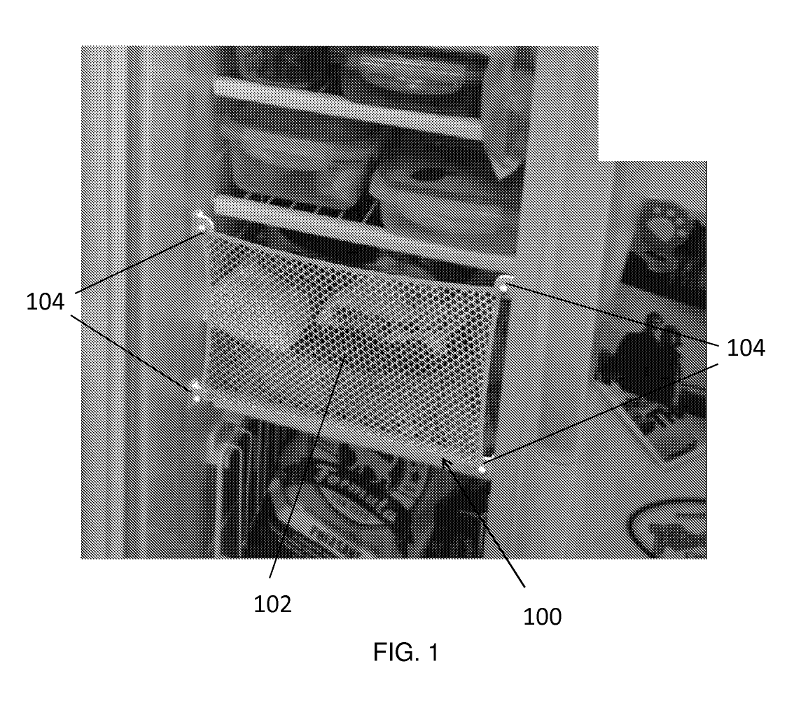

This invention is directed to shelf retainer devices. Particular devices of the invention are particularly useful when used in freezers and refrigerators. A specific embodiment of the invention is represented in FIG. 1, which shows a refrigerator/freezer with the shelf retainer device 100 of the present invention installed in the freezer compartment. The shelf retainer device 100 includes a retaining panel 102 and four mounting units 104, which releasably attach the retaining panel 102 to the inside walls of the freezer or refrigerator. The shelf retainer device 100 retains the food items in the freezer or refrigerator for improved safety and increased storage capacity.

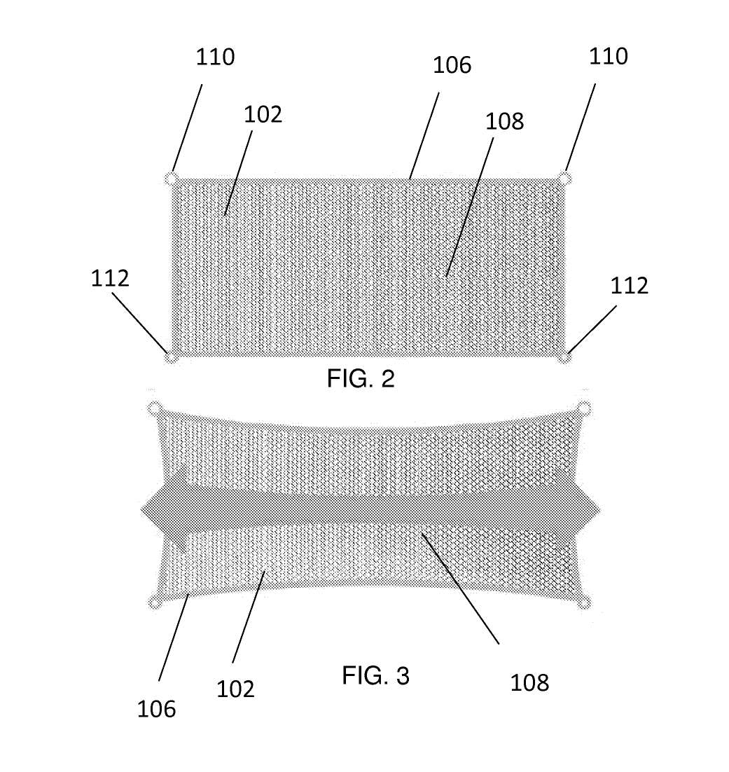

FIG. 2 illustrates a retaining panel 102 of the shelf retainer device 100 in a relaxed position. The retaining panel 102 is approximately rectangular in shape and is close in size to the shelf openings in the freezer or refrigerator. The retaining panel 102 may be of fixed size, but preferably it is elastic and therefore stretchable in the horizontal direction, and optionally in the vertical direction as well, so that it can accommodate to a range of shelf opening sizes, as shown in FIG. 3. The retaining panel 102 is preferably made from an open mesh material 108 to allow a clear view of the shelf contents and to allow air circulation within the freezer or refrigerator compartment. Most preferably, the retaining panel 102 will be made from a mesh material 108 with openings in the range of approximately 0.1 to 1 inch in size. The openings in the mesh material 108 may be any convenient or decorative shape, including circular, oval, square, triangular, diamond shaped, or hexagonal as shown in the drawings. The mesh material 108 of the retaining panel 102 may be produced by various manufacturing processes, including weaving, knitting, molding or composite construction techniques. Suitable materials for the mesh material 108 include, but are not limited to cotton, nylon, polyamide elastomers, polyester, polyethylene, polypropylene, ethylene vinyl acetate, lycra, latex rubber, butyl rubber, nitrile rubber, polyurethane, silicone and various blends or composites thereof.

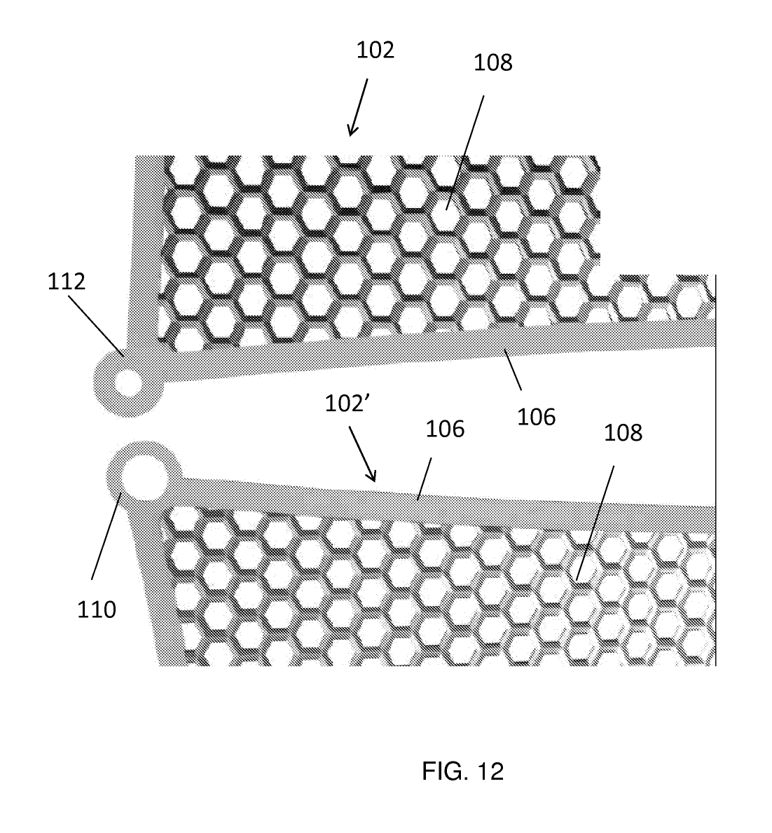

The mesh material 108 of the retaining panel 102 is framed by a border 106 having top, bottom, left and right sides. In one preferred embodiment, the border 106 is made of an elastomeric material, which allows the retaining panel 102 to stretch. Suitable materials for the border 106 include, but are not limited to nylon, polyamide elastomers, polyester, polyethylene, polypropylene, ethylene vinyl acetate, lycra, latex rubber, butyl rubber, nitrile rubber, polyurethane, silicone and various blends or composites thereof. The border 106 may be molded integrally with or overmolded onto the mesh material 108 of the retaining panel 102. Alternatively, the border 106 can be attached to the mesh material 108 of the retaining panel 102 by sewing, adhesive or using various fasteners. At each corner of the retaining panel 102 is a loop 110, 112 for attaching the retaining panel 102 to the mounting units 104. The attachment loops 110, 112 will preferably be made of an elastomeric material and may optionally be molded integrally with the border 106. Suitable materials for the attachment loops 110, 112 include, but are not limited to nylon, polyamide elastomers, polyester, polyethylene, polypropylene, ethylene vinyl acetate, lycra, latex rubber, butyl rubber, nitrile rubber, polyurethane, silicone and various blends or composites thereof. As shown in FIGS. 2 and 3 and in the detail drawing of FIG. 12, the upper attachment loops 110 on the retaining panel 102 may be larger in size than the lower attachment loops 112. The function of this feature will be explained in further detail below.

In an alternate embodiment, the border 106 may be constructed as a tubular sleeve to accept a drawstring, which encircles the retaining panel 102 and forms attachment loops at each corner. Optionally, the drawstring may be elastic. A drawstring lightener may be used for convenience.

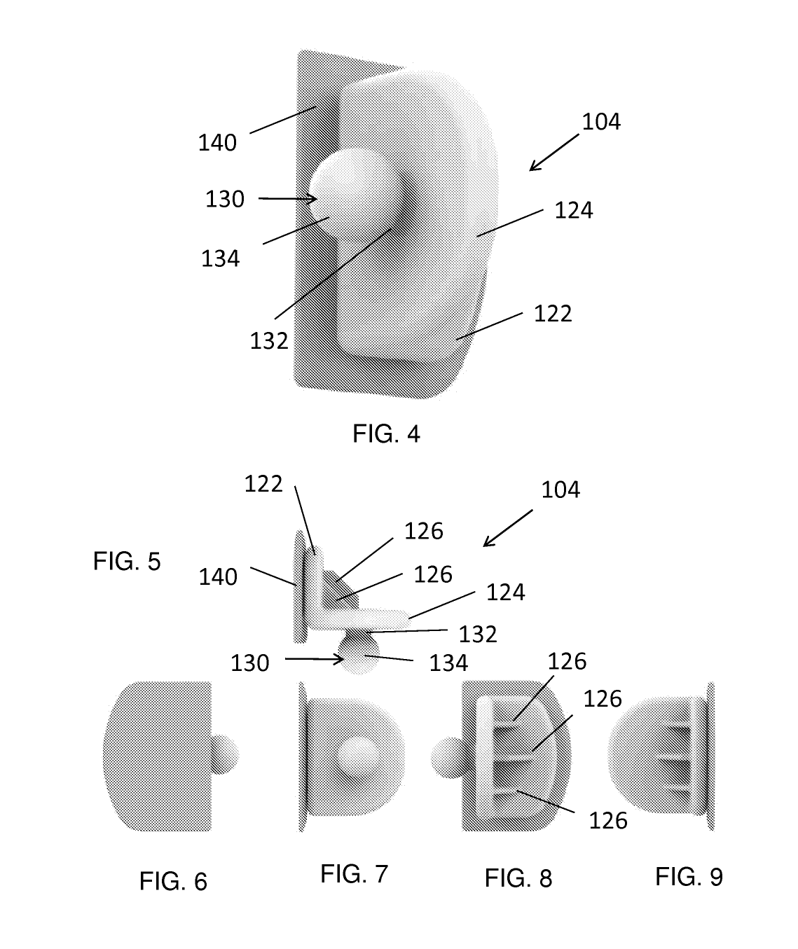

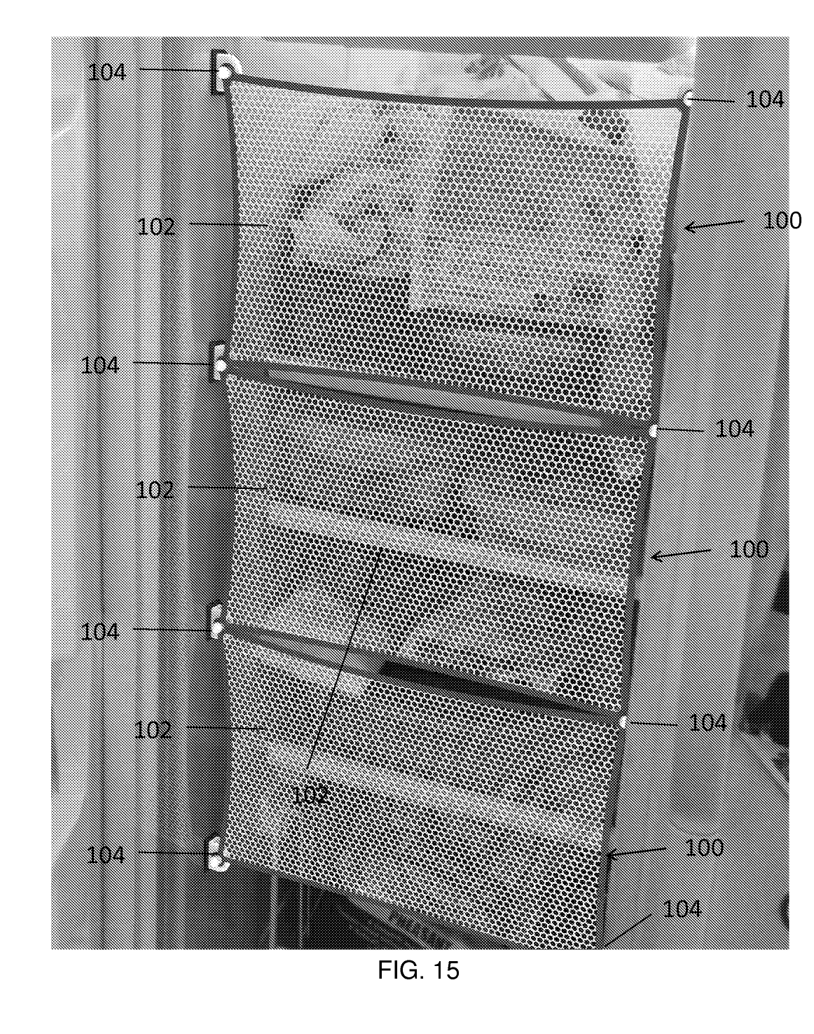

FIG. 4 is a perspective drawing of a mounting unit 104 for use in the shelf retainer device 100 of the present invention. FIG. 5 is a top view, FIG. 6 is a left side view, FIG. 7 is a front view, FIG. 8 is a right side view, and FIG. 9 is a back view of the mounting unit in FIG. 4. As seen in the top view in FIG. 5, the mounting unit 104 has an approximately L-shaped bracket 120 having a side plate 122 and a front plate 124 connected together at a right angle. Optionally, the L-shaped bracket 120 may have one or more approximately triangular buttresses 126 that connect the side plate 122 and the front plate 124 for additional strength. At least one attachment knob 130 with an optional post 132 and a bulbous head 134 extends from a front surface of the front plate 124. The head 134 of the attachment knob 130 may be approximately spherical as shown or it may be teardrop, conical or mushroom shaped. Alternatively, the attachment knob 130 may be somewhat hook-shaped. The mounting units 104 may be manufactured from plastic or metal by various methods, including injection molding, machining and additive manufacturing. Suitable materials for the mounting units 104 include, but are not limited to polystyrene, nylon, polyester, polyethylene, polypropylene, polyurethane and various blends or composites thereof. Multiple attachment knobs 134 may extend from the front plate 124 as an alternative to what is shown in FIG. 15.

Returning again to FIGS. 4-9, a mounting means 140 is provided for attaching the side plate 122 of each mounting unit 104 to an inside wall of the freezer or refrigerator. The mounting means 140 may be configured with one or more suction cups, micro suction cups, nanosuction material, a hook-and-loop fastener, magnets, an adhesive (e.g., glue, epoxy, adhesive tape). Examples of suitable nanosuction materials include EverSTIK™ available from UM! Brands and NanoSuction™ pads available from 1.0 Innovations, LLC. A removable adhesive, for example 3M COMMAND Adhesive Strips, can provide a strong, reliable attachment without damaging the walls of the freezer or refrigerator. Other fasteners, such as screws and nails, may also be used when the shelf retainer device is used with conventional shelving (e.g., in a pantry).

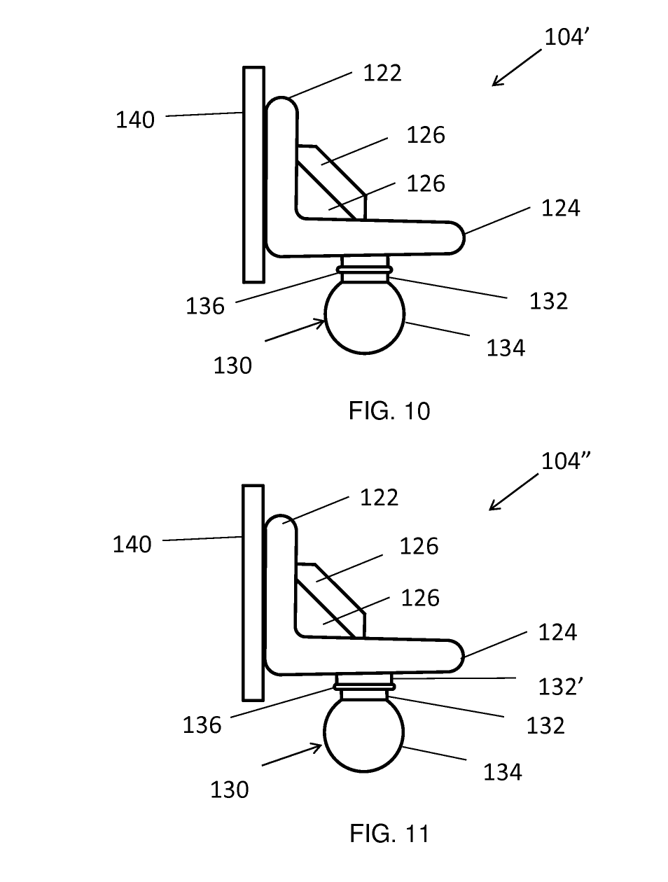

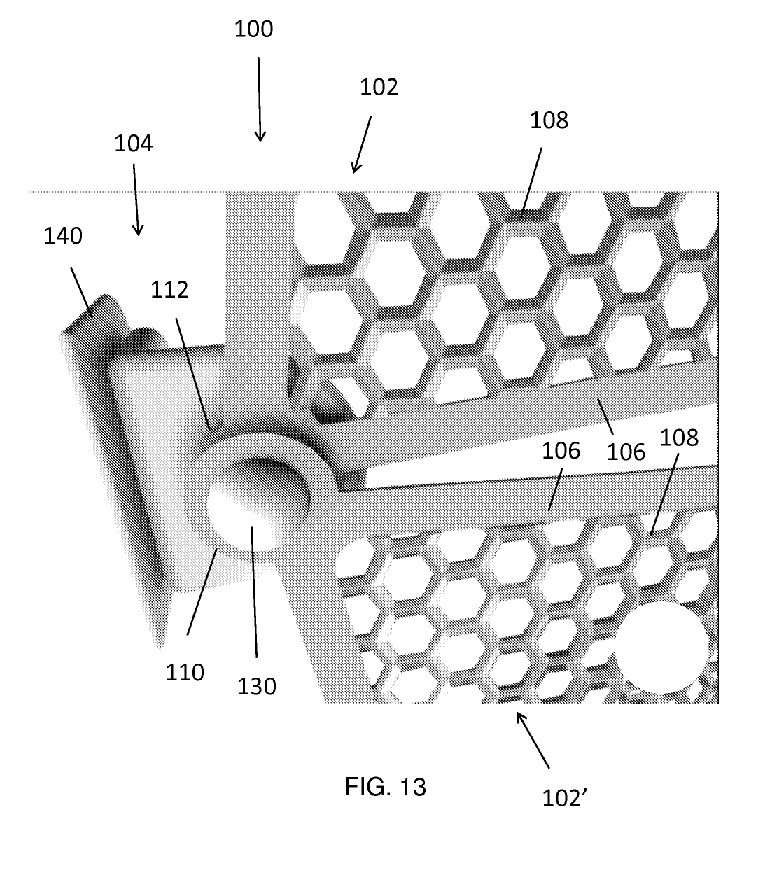

FIG. 10 is a top view showing additional features of the mounting unit 104′ of the shelf retainer device 100. The mounting unit 104′, in most respects, is the same as the mounting bracket 104 shown in FIGS. 4-9. In addition to the features described above, the mounting unit 104′ of FIG. 10 has an annular ridge 136 around the post 132 of the attachment knob 130. The annular ridge 136 provides additional retaining force to hold the lower attachment loop 112 of the upper retaining panel 102 on the attachment knob 130 when assembled as described further below and as shown in FIG. 13. This feature allows the option of making the retaining panels 102 with the upper attachment loops 110 and lower attachment loops 112 of the same diameter because the additional retaining force provided by the annular ridge 136 will prevent inadvertent detachment of the lower attachment loops 112 of the upper retaining panel 102. With this feature, the user will not have to be concerned with the up or down orientation of the retaining panels 102 when assembling and using the shelf retainer device 100.

FIG. 11 is a top view showing additional features of the mounting unit 104″ of the shelf retainer device 100. The mounting unit 104″, in most respects, is the same as the mounting bracket 104 shown in FIGS. 4-9. In addition to the features described above, the post 132 of the attachment knob 130 has an enlarged diameter portion 132′ near the base of the post 132. The enlarged diameter portion 132′ provides additional retaining force to hold the lower attachment loop 112 of the upper retaining panel 102 on the attachment knob 130 when assembled as in FIG. 13. Optionally, the mounting unit 104″ may also have an annular ridge 136 around the post 132 at the end of the enlarged diameter portion 132′ to provide even more retaining force. This feature also allows the option of making the retaining panels 102 with the upper attachment loops 110 and lower attachment loops 112 of the same diameter because the additional retaining force provided by the enlarged diameter portion 132′ (and optionally the annular ridge 136) will prevent inadvertent detachment of the lower attachment loops 112 of the upper retaining panel 102. With this feature, the user will not have to be concerned with the up or down orientation of the retaining panels 102 when assembling and using the shelf retainer device 100.

In an alternative embodiment, the post contains a channel having a width that accommodates one attachment loop and a depth that prevents the easy removal of that loop. Different loops can have different widths, thereby providing another means of differentiating between the top and bottom parts of a retaining panel.

FIG. 12 shows an embodiment of the invention wherein the upper attachment loops 110 on the retaining panel 102 are larger in size than the lower attachment loops 112. The inside diameter of the two lower attachment loops 112 on each retaining panel 102 are sized to provide a very snug fit over the attachment knob 130 on the mounting units 104 so that the lower corners of the retaining panel 102 will be very firmly attached and will not become detached inadvertently. The inside diameter of the upper attachment loops 110, on the other hand, will have only a slight interference fit over the attachment knob 130 on the mounting units 104 so that the upper corners of the retaining panel 102 can be readily attached and detached by the consumer for easy access to the shelf space, but will hold firmly enough to prevent food items from falling off the shelf. FIG. 1 shows a single shelf retainer device 100 with one retaining panel 102 mounted in this manner inside a freezer compartment using four mounting units 104.

As shown in FIG. 13, two adjacent retaining panels 102, 102′ can be connected to a single mounting unit 104. First, the smaller diameter, lower attachment loop 112 of the upper retaining panel 102 is attached to the attachment knob 130 on the mounting unit 104, and then the larger diameter, upper attachment loop 110 of the lower retaining panel 102′ is attached to the same attachment knob 130. Thus, the upper attachment loop 110 of the lower retaining panel 102′ can be readily attached and detached from the mounting unit 104, while the lower attachment loop 112 of the upper retaining panel 102 remains firmly attached to the attachment knob 130.

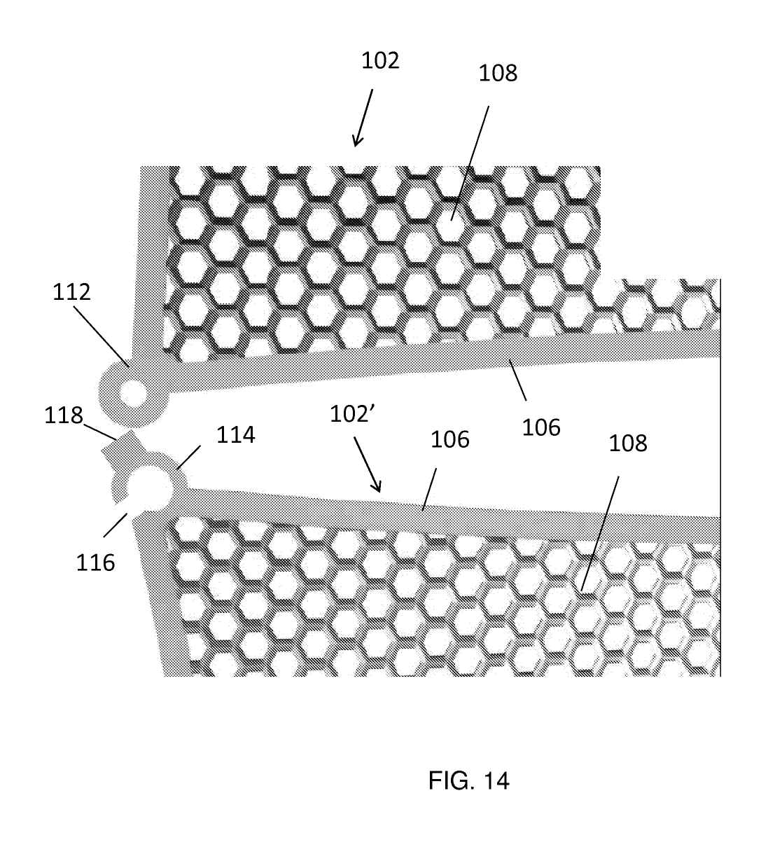

FIG. 14 is a detail view showing additional features of the corners of two adjacent retainer panels 102, 102′ of the shelf retainer device 100. In FIG. 14, the upper attachment loop 114 of the lower retaining panel 102′ is made in a hook-like configuration with an opening 116 to facilitate attaching and detaching the upper attachment loops 114 to the attachment knobs 130 on the mounting units 104 as shown in FIG. 13. Optionally, the lower attachment loops 112 of the retainer panels 102, 102′ may also be made in a hook-like configuration. FIG. 14 shows another optional feature of a tab 118 extending from the upper attachment loop 114 of the lower retaining panel 102′ to facilitate grasping and manipulating the upper attachment loops 114 for attaching and detaching the lower retaining panel 102′ to the mounting units 104 of the shelf retainer device 100. The tabs 118 may be used with the hook-like attachment loops 114 shown in FIG. 14 or the closed attachment loops 110 shown in FIGS. 2-3 and 12-13. Optionally, the lower loops 112 of the retainer panels 102, 102′ may also be made with tabs 118.

FIG. 15 shows a refrigerator/freezer with a shelf retainer device 100 installed on multiple shelves of the freezer compartment. In this configuration, each retaining panel 102 can share a pair of mounting units 104 with the panel immediately above or below it. Two, three or more shelf retainer devices 100 can be combined this way. Alternatively, separate mounting units 104 can be used for each retaining panel 102. As another alternative, some or all of the mounting units 104 can be configured with two attachment knobs 130, one for each retaining panel 102 above and below it.

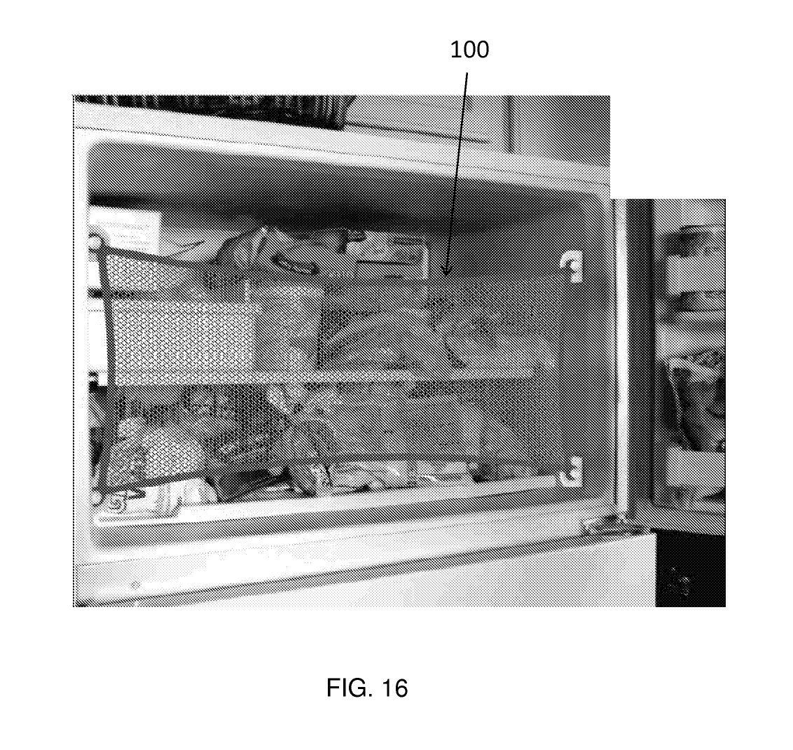

Various sizes and shapes of the shelf retainer device 100 can be provided to accommodate different sizes and styles of refrigerator/freezers. For example, FIG. 16 shows a freezer-on-top style refrigerator/freezer with a shelf retainer device 100 installed in the freezer compartment. Multiple side-by-side shelf retainer devices 100 can be used in this style of freezer in order to provide partial access to the freezer compartment while retaining loose items in the remainder of the freezer compartment.

What is claimed is:

1. A shelf retainer device comprising a retaining panel and a plurality of mounting units, wherein:
the retaining panel comprises an open mesh material and a plurality of attachment loops, and;
each of the plurality of mounting units comprises an approximately L-shaped bracket having a side plate and a front plate, from which front plate extends at least one attachment knob comprising a bulbous head that fits within one of the attachment loops.

2. The shelf retainer device of claim 1, wherein the open mesh material is stretchable.

3. The shelf retainer device of claim 2, wherein the open mesh material is framed by a border.

4. The shelf retainer device of claim 3, wherein the attachment loops are molded integrally with or overmolded onto the border.

5. The shelf retainer device of claim 4, wherein the attachment loops are stretchable, and must be stretched to fit over the bulbous head of an attachment knob.

6. The shelf retainer device of claim 5, wherein the retaining panel has a top edge having at least one attachment loop with a first inner diameter, and a bottom edge having at least one attachment loop with a second inner diameter, wherein the second inner diameter is smaller than the first inner diameter.

7. The shelf retainer device of claim 1, wherein the retaining panel has a top edge having at least one top attachment loop and a bottom edge having at least one bottom attachment loop, wherein the top attachment loop is hook-shaped and the bottom attachment loop is stretchable and must be stretched to fit over the bulbous head of an attachment knob.

8. The shelf retainer device of claim 1, wherein the L-shaped bracket comprises one or more approximately triangular buttresses that connect the side plate and the front plate.

9. The shelf retainer device of claim 1, wherein the attachment knob comprises a post separating the bulbous head from the front plate.

10. The shelf retainer device of claim 9, wherein an annular ridge encircles the post, dividing the post into a first segment between the front plate and the annular ridge, and a second segment between the annular ridge and the bulbous head.

11. The shelf retainer device of claim 10, wherein the diameter of the first segment is larger than the diameter of the second segment.

12. The shelf retainer device of claim 1, wherein an adhesive covers at least part of the side plate.

13. The shelf retainer device of claim 1, wherein a suction device is attached to the side plate.

14. A method of retaining items on a shelf bounded by at least two walls, which comprises:
providing a retaining panel comprising an open mesh material and a plurality of attachment loops;
affixing a plurality of mounting units to the at least two walls, wherein each mounting unit comprises an approximately L-shaped bracket having a side plate and a front plate, from which front plate extends at least one attachment knob comprising a bulbous head; and
fitting the attachment loops over the bulbous heads of the mounting units.

15. The method of claim 14, wherein the mounting units are affixed to the walls by an adhesive.

16. The method of claim 14, wherein the retaining panel has a top edge having at least one attachment loop with a first inner diameter, and a bottom edge having at least one attachment loop with a second inner diameter, wherein the second inner diameter is smaller than the first inner diameter.
